(19) United States
(12) Patent Application Publication
(10) Pub. No.: US 2022/0408663 A1
(43) Pub. Date: Dec. 29, 2022

(54) Blower With Electrostatic Discharge System

(71) Applicant: Black & Decker, Inc., New Britain, CT (US)

(72) Inventors: Justin Cooper, Shrewsbury, PA (US); Nathan Greene, Baltimore, MD (US); Brian E. Poole, Lutherville, MD (US); Michael Kowalski, Towson, MD (US)

(21) Appl. No.: 17/902,222

(22) Filed: Sep. 2, 2022

Related U.S. Application Data
(63) Continuation of application No. PCT/US2021/020776, filed on Mar. 4, 2021.
(60) Provisional application No. 62/984,849, filed on Mar. 4, 2020.

(51) Int. Cl. A01G 20/47; H01M 50/247; H01M 50/298; F04D 29/40; F04D 25/06

(52) U.S. Cl. CPC A01G 20/47; H01M 50/247; H01M 50/298; F04D 29/403; F04D 25/0673; H01M 2220/30

(57) ABSTRACT

The present invention is directed to an outdoor blower that is capable of safely releasing any electrostatic charge that builds up in the blower. During the operation of the blower, electric charge builds up in the housing and components of the blower as particles in the air are moved through the blower. The blower includes a wire contact in the handle that is electrically connected to various other components in the blower. As electric charge is built up in the blower, it can be passed to the wire contact, which is graspable by a user, who acts as a ground and is able to release any charge that builds up.

### CROSS-REFERENCE TO RELATED APPLICATION

This application is a continuation of PCT Application No. PCT/US2021/020776, filed Mar. 4, 2021, which claims priority to Provisional Patent Application No. 62/984,849, filed Mar. 4, 2020. The entire contents of that application are expressly incorporated herein by reference thereto.

### FIELD OF THE INVENTION

The present disclosure relates to a blower capable of discharging electrostatic buildup.

### BACKGROUND OF THE INVENTION

This section provides background information related to the present disclosure which is not necessarily prior art.

Powered blowers are well known devices used to clear indoor and outdoor spaces by blowing air out of a tube to clear away dust, dirt, leaves and other debris. The blowers can be powered by engines or electric motors.

Recently, these blowers have gotten more powerful to push through higher volumes of air through the fan and tubing. Particles in the air being blow create static electricity as they contact the interior of the blower and build up a static charge. An unwitting user may then get shocked by the static electricity when they grab the blower.

### BRIEF SUMMARY OF THE INVENTION

In accordance with the invention, a blower incorporates various methods to discharge the static electricity as it builds up. This reduces the likelihood and the magnitude of the static discharge to the user.

In an embodiment of the invention, a first end of an exposed metal wire is placed in the handle and connected through a fan housing or baffle to a second end of the wire that is secured to a control module.

In another embodiment of the invention the metal wire in the handle is connected to the baffle, with its end being secured to aluminium tape wrapped around the wires near the control module.

In another embodiment of the invention, the metal wire in the handle is connected to the baffle, with its end being secured to aluminium tape overlaying the wires.

In another embodiment of the invention, the metal wire in the handle is connected to the baffle, with its end secured to aluminium tape covering just the wires in the control module.

In another embodiment of the invention, the metal wire in the handle is connected to a terminal of a battery that powers the blower.

In another embodiment of the invention, the metal wire in the handle is connected to a screw for the baffle.

In another embodiment of the invention, the metal wire in the handle is connected to a screw in the baffle, the control module and a stator of the motor.

In another embodiment of the invention, the metal wire in the handle is connected to aluminium tape wrapped around the control module.

In another embodiment of the invention, the metal wire in the handle is connected to a screw in the blower housing.

In another embodiment of the invention, the metal wire in the handle is connected to a stator in the motor.

In another embodiment of the invention, the metal wire in the handle is connected to a stator of the motor and a terminal of a battery.

In another embodiment of the invention, the metal wire connects the stator and rotor of a motor to a terminal of a battery.

In another embodiment of the invention, the metal wire connects the stator of the motor to a terminal of the battery.

In another embodiment of the invention, the metal wire in the handle is connected to the fan housing or baffle through a bracket contacting the control module and a terminal for the battery.

In another embodiment of the invention, the metal wire in the handle is connected to the fan housing or baffle and a terminal for the battery.

In yet another embodiment of the invention, the metal wire in the handle is not connected to anything but rather its free end is allowed to float within the housing.

### BRIEF DESCRIPTION OF THE INVENTION

Further features and advantages of the present invention will be better understood by reference to the following description, which is given by way of example and in association with the accompanying drawings, in which:

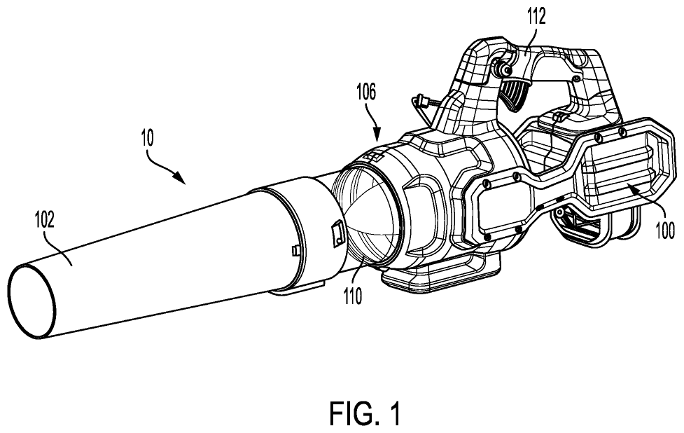

FIG. 1 is a perspective view of a blower of the present invention;

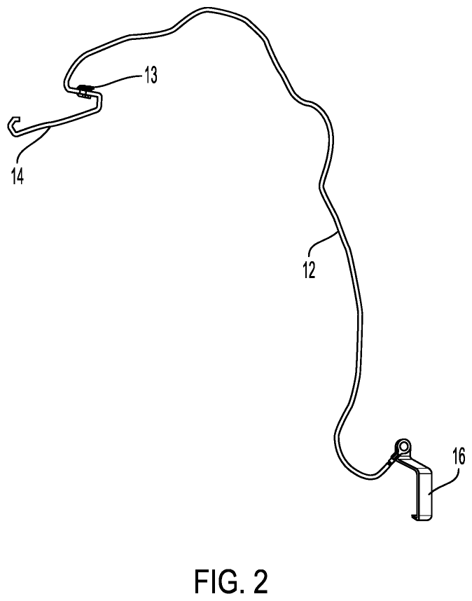

FIG. 2 is a metal wire incorporated into the blower;

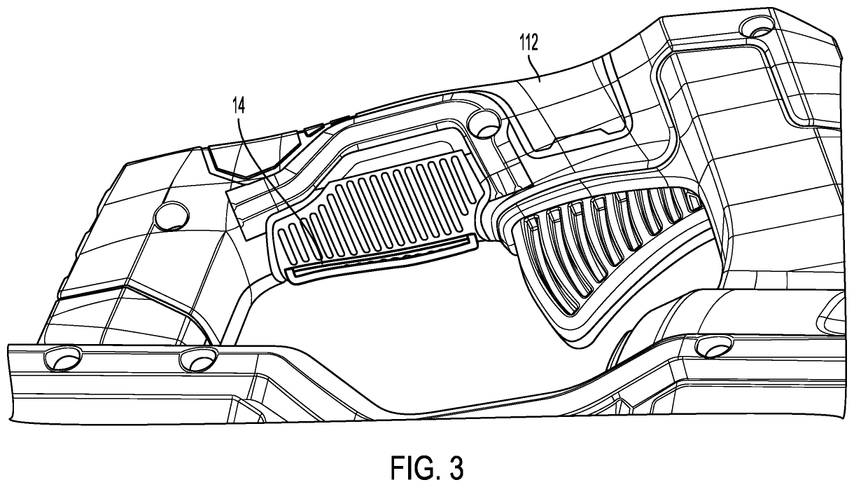

FIG. 3 is a handle of the blower;

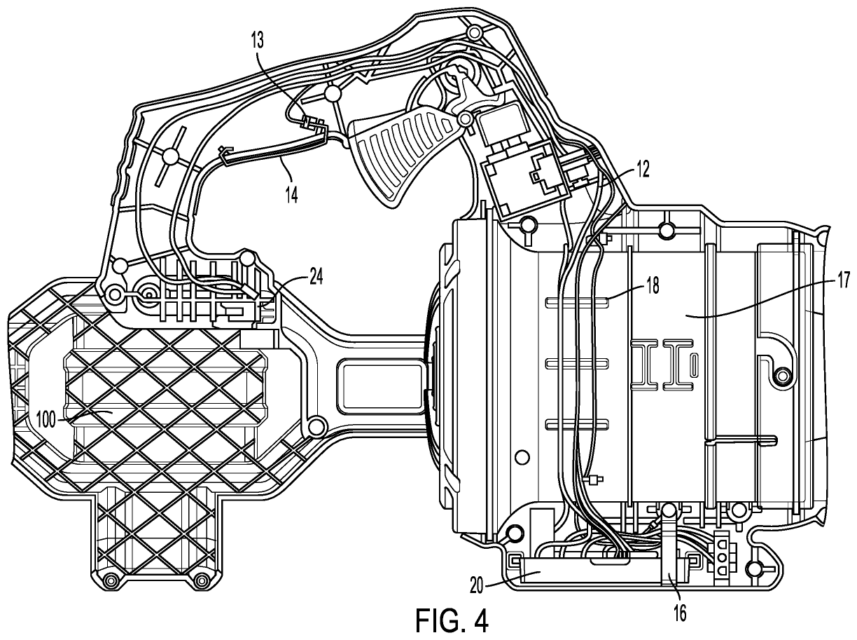

FIG. 4 is a side interior view of the blower;

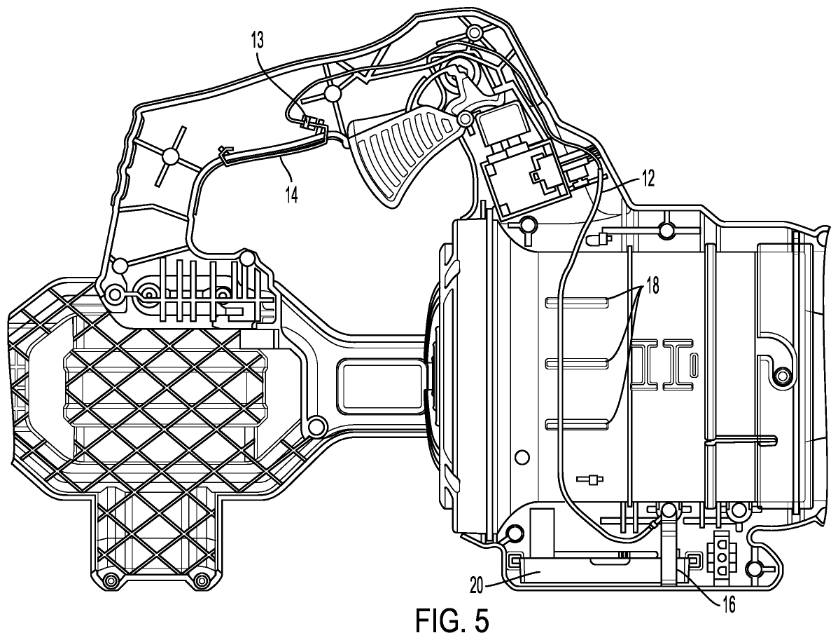

FIG. 5 is similar to FIG. 4, with wires removed for clarity;

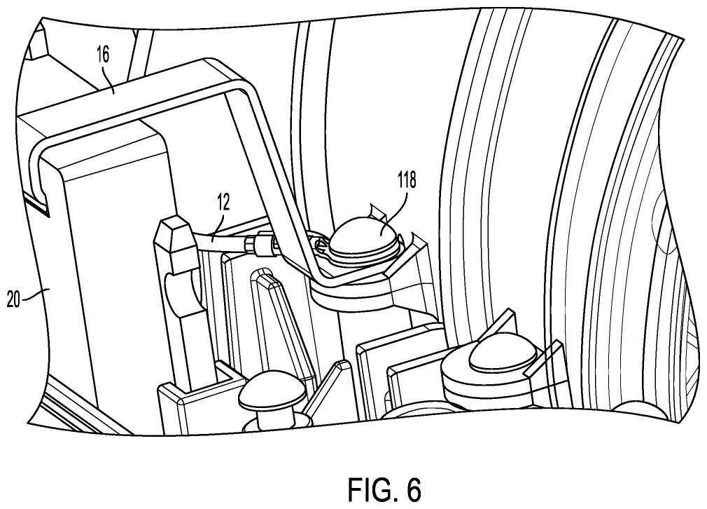

FIG. 6 is a perspective view of a bottom portion of the blower showing the metal wire, control module and baffle;

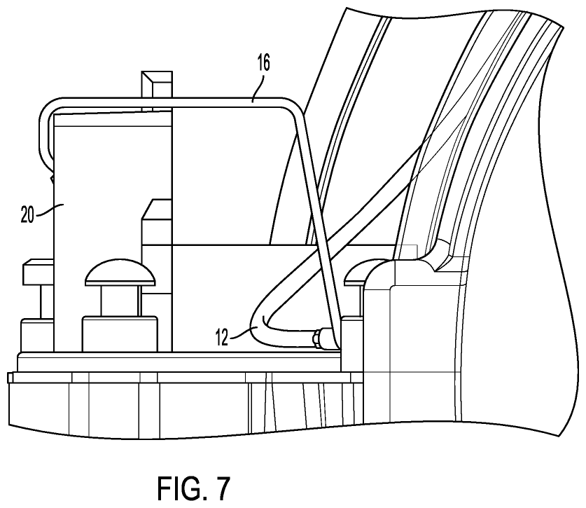

FIG. 7 is a front view of FIG. 6;

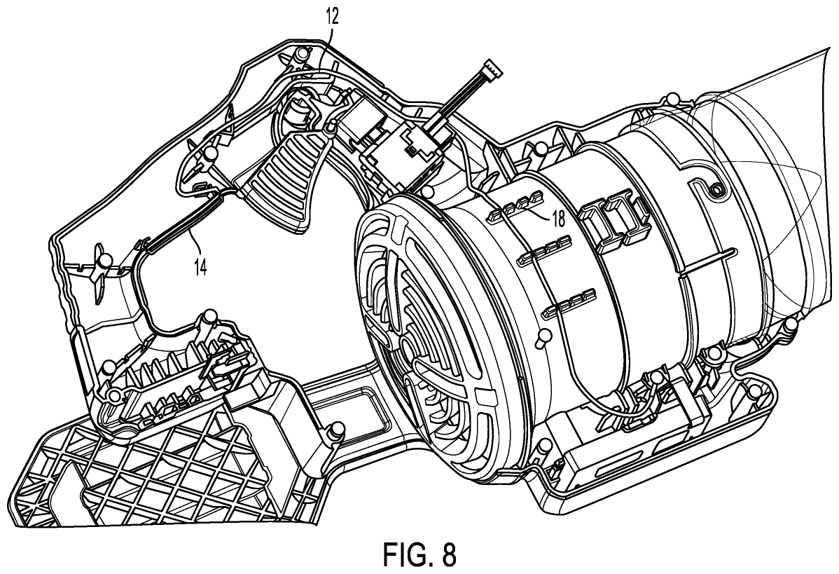

FIG. 8 shows a rear interior view of the blower;

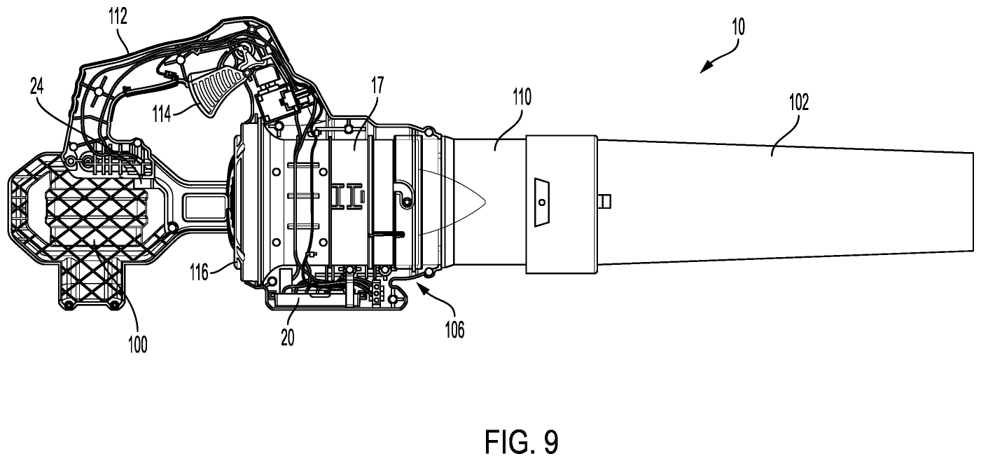

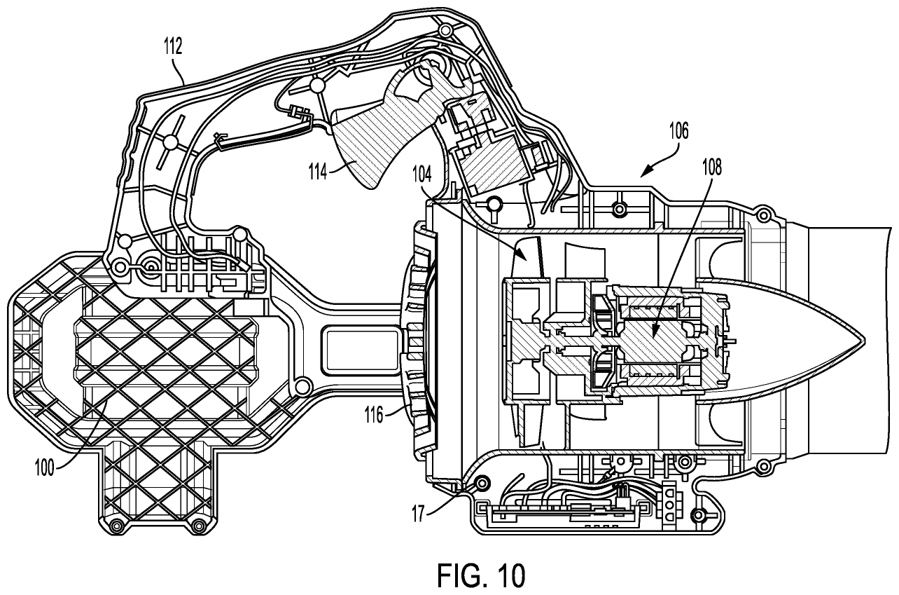

FIGS. 9-10 are side interior views of the blower;

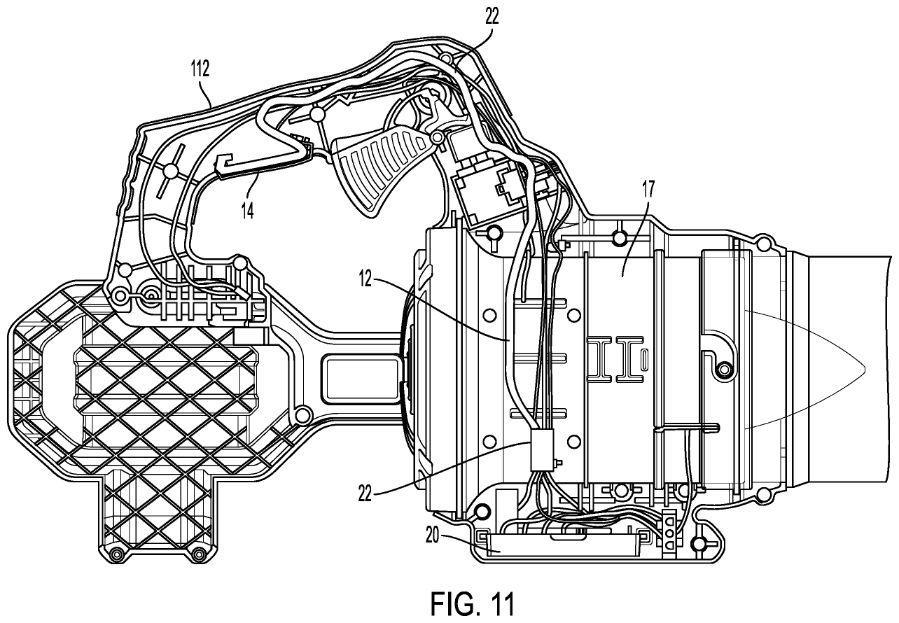

FIG. 11 shows a second embodiment of the invention;

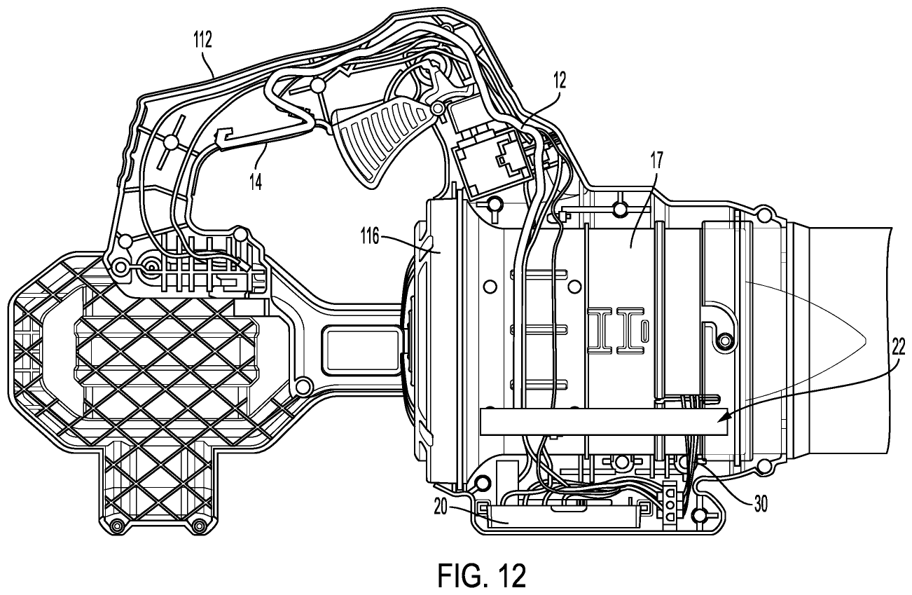

FIG. 12 shows a third embodiment of the invention;

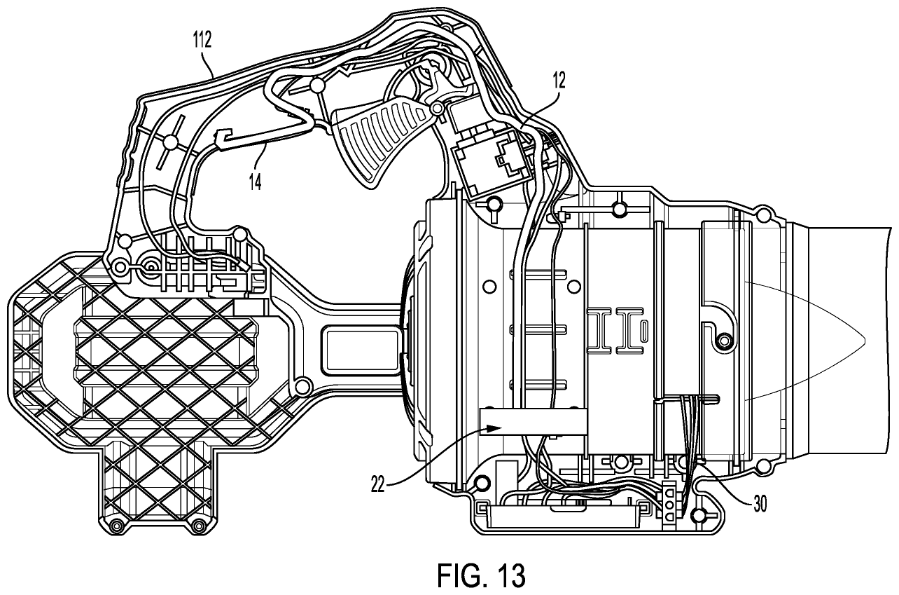

FIG. 13 shows a fourth embodiment of the invention;

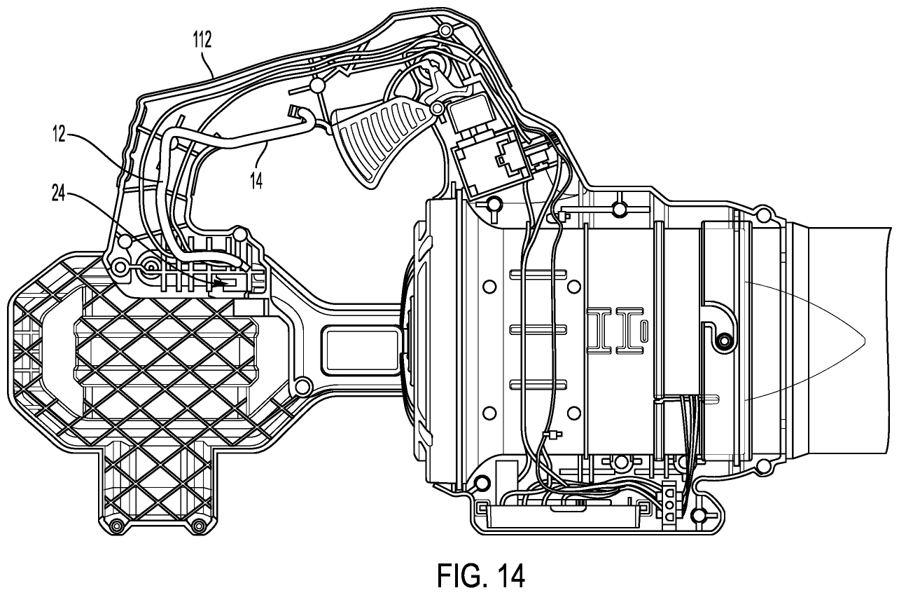

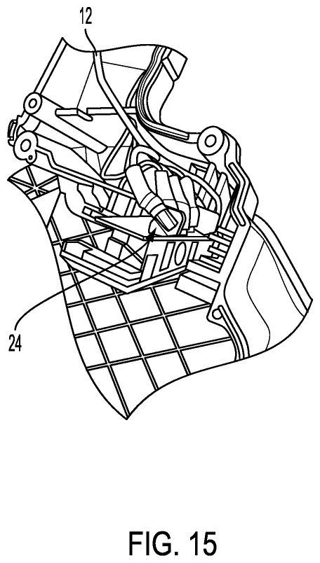

FIGS. 14 and 15 show a fifth embodiment of the invention;

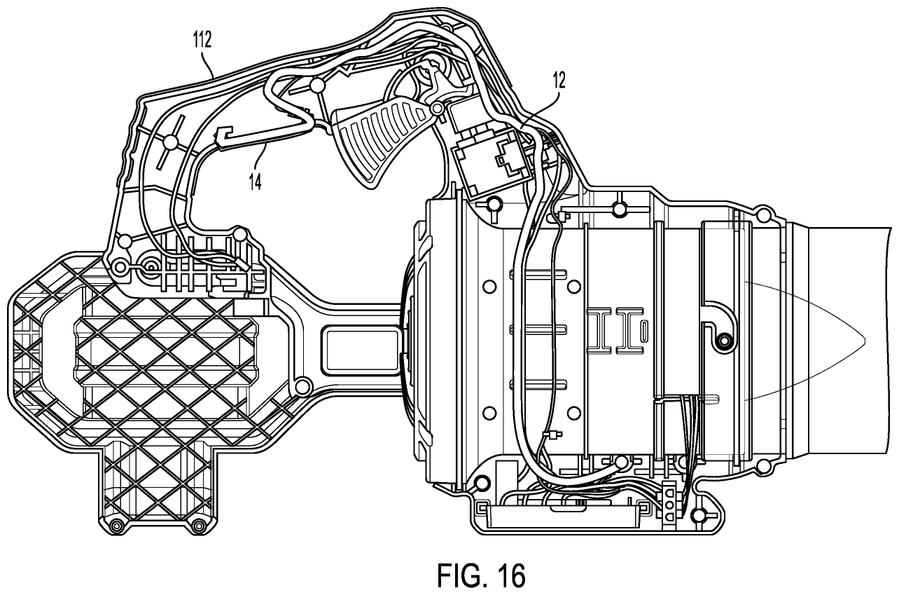

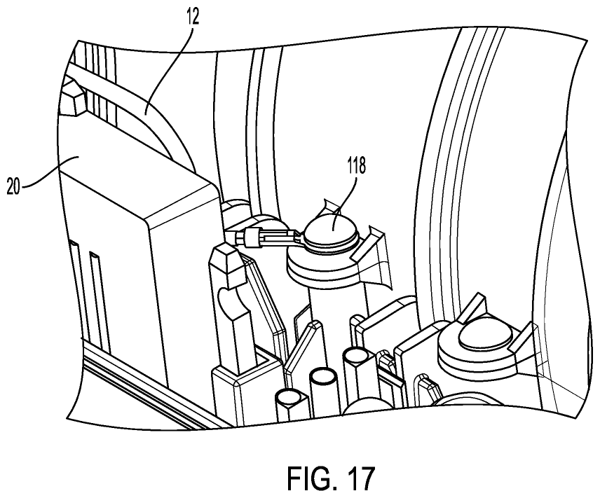

FIGS. 16 and 17 show a sixth embodiment of the invention;

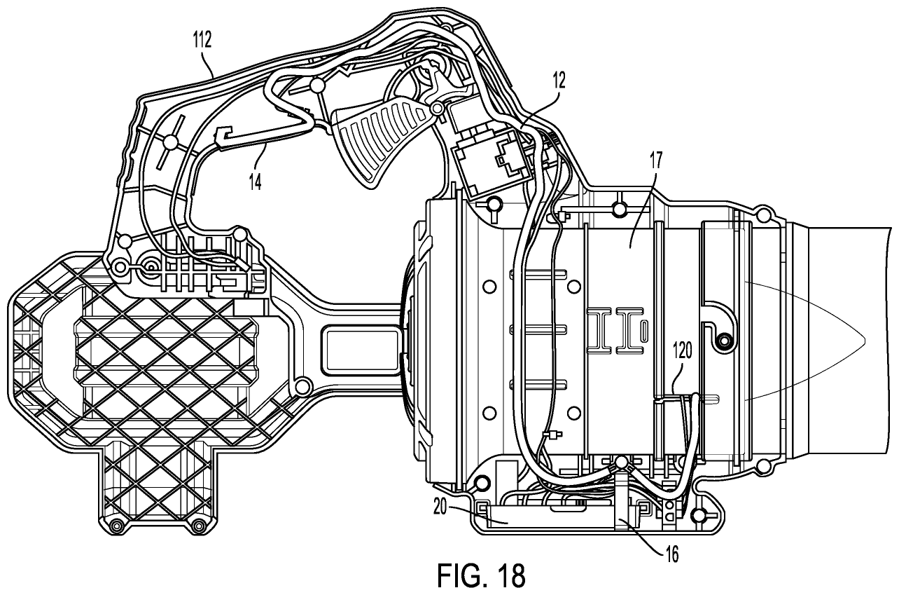

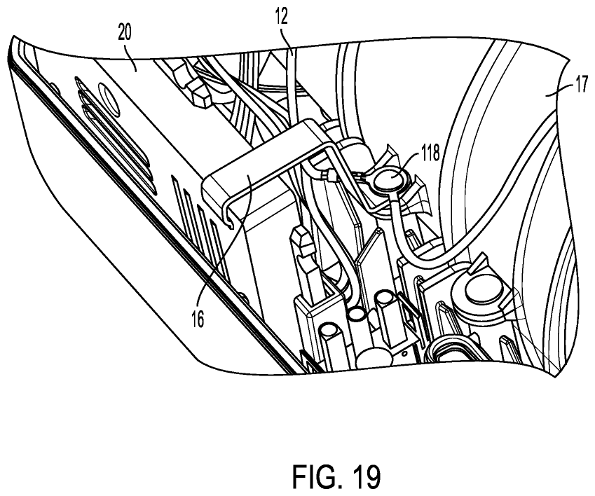

FIGS. 18-20 show a seventh embodiment of the invention;

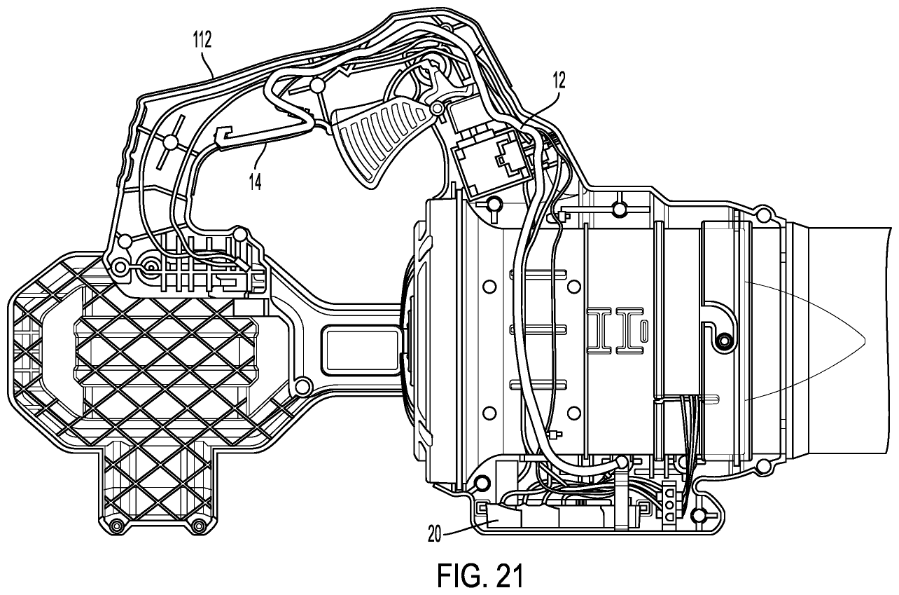

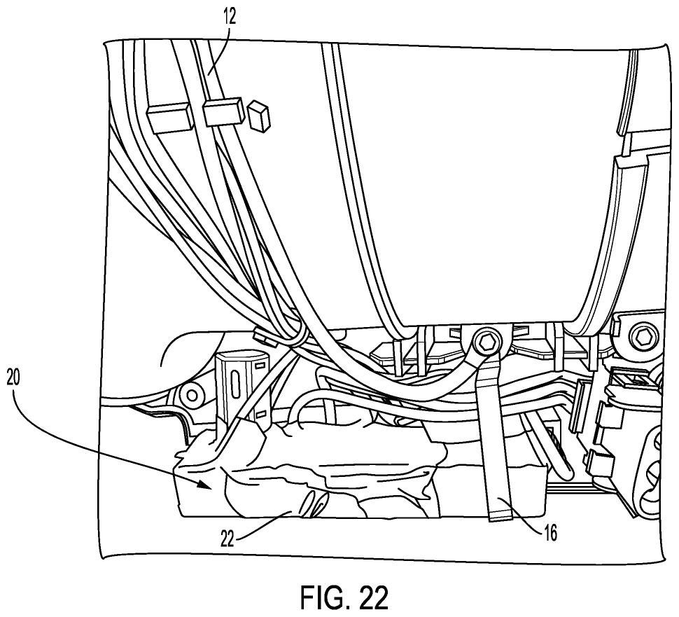

FIGS. 21 and 22 show an eighth embodiment of the invention;

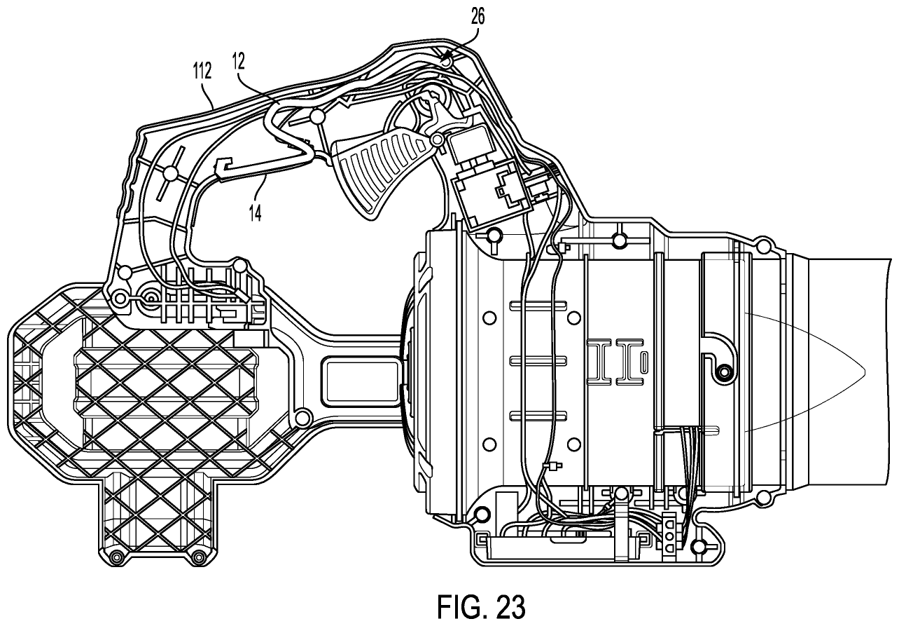

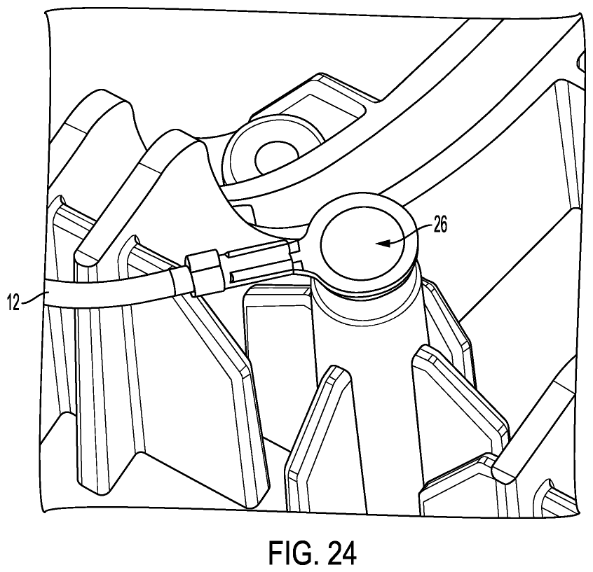

FIGS. 23 and 24 show a ninth embodiment of the invention;

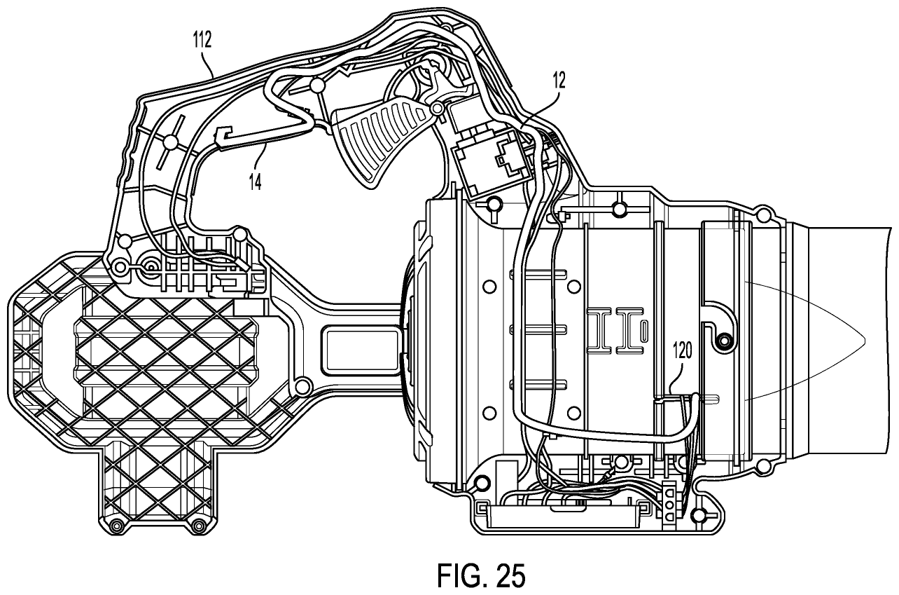

FIG. 25 shows a tenth embodiment of the invention;

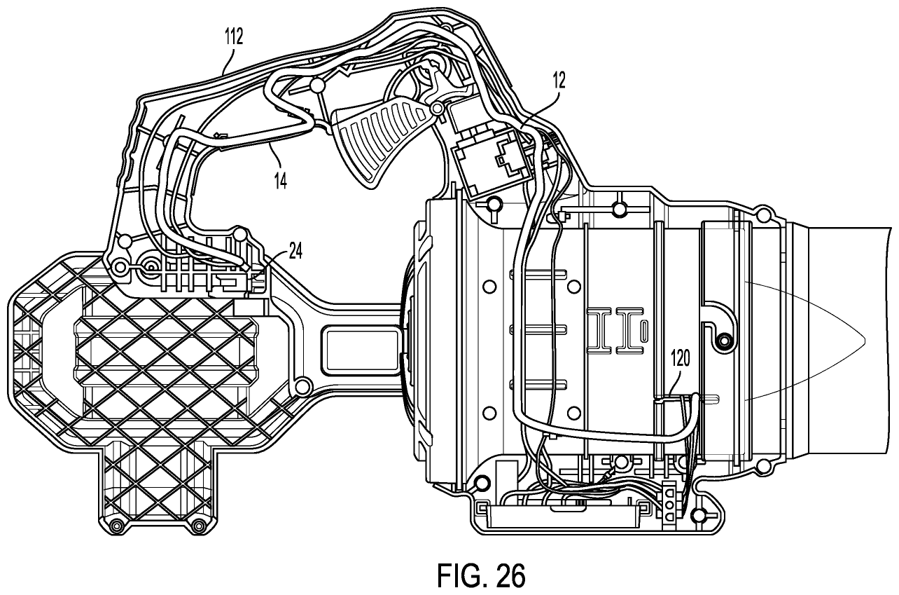

FIG. 26 show a eleventh embodiment of the invention;

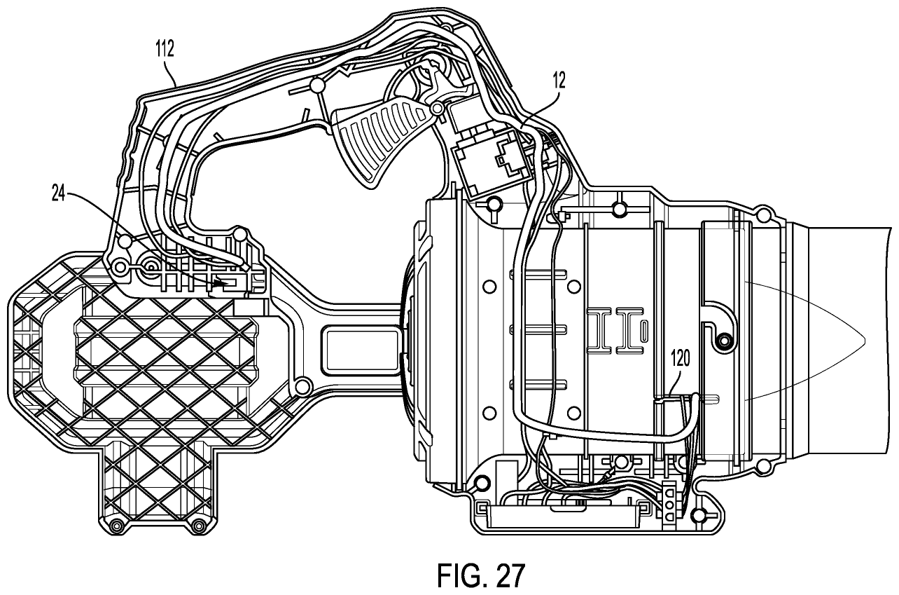

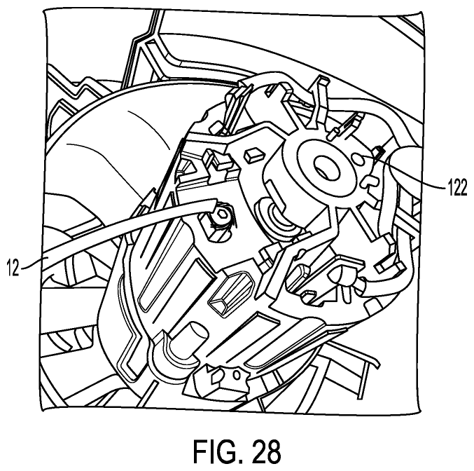

FIGS. 27 and 28 show a twelfth embodiment of the invention;

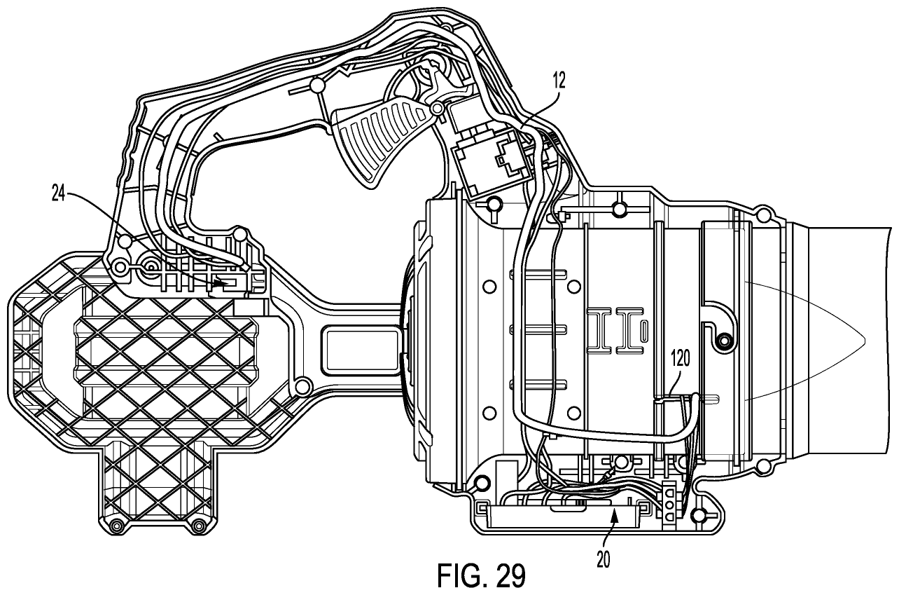

FIG. 29 show a thirteenth embodiment of the invention;

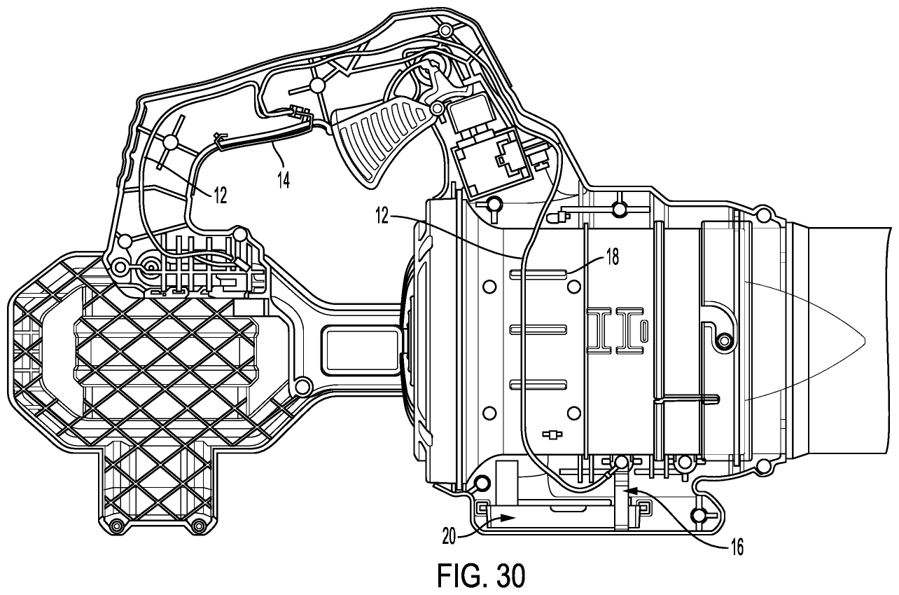

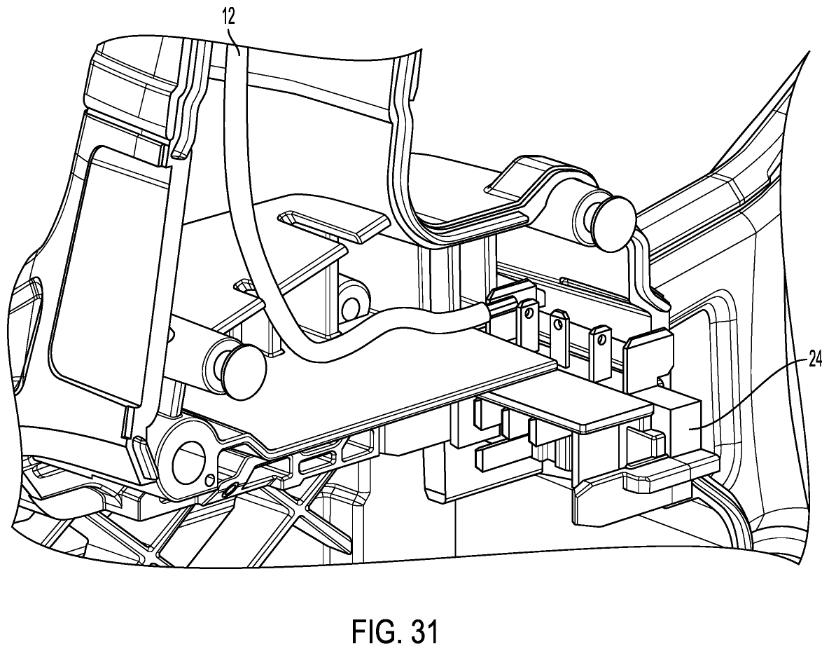

FIGS. 30 and 31 show a fourteenth embodiment of the invention;

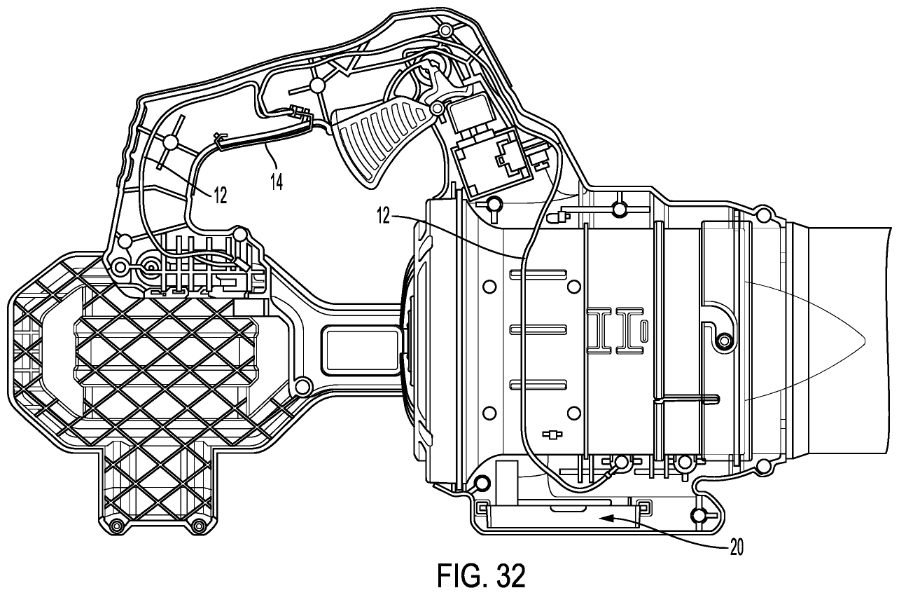

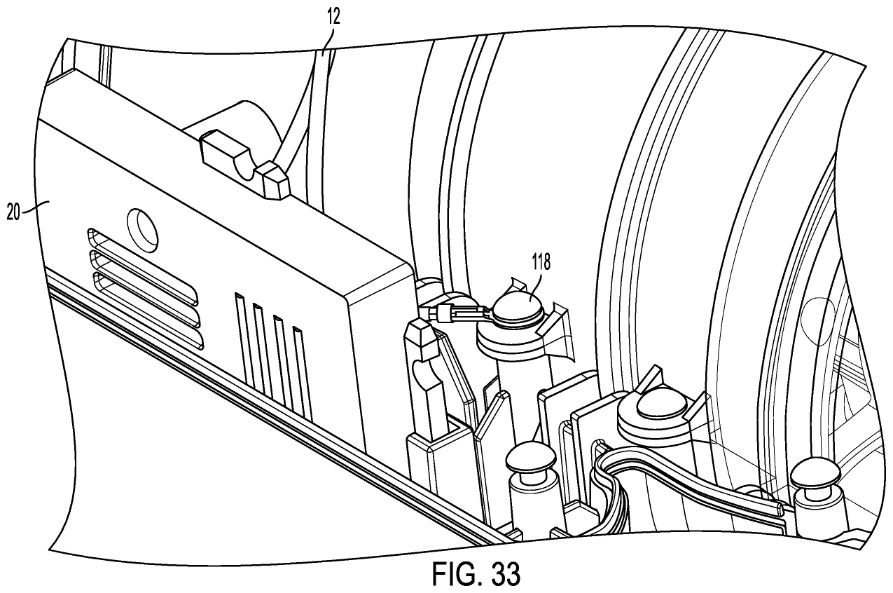

FIGS. 32 and 33 show a fifteenth embodiment of the invention; and

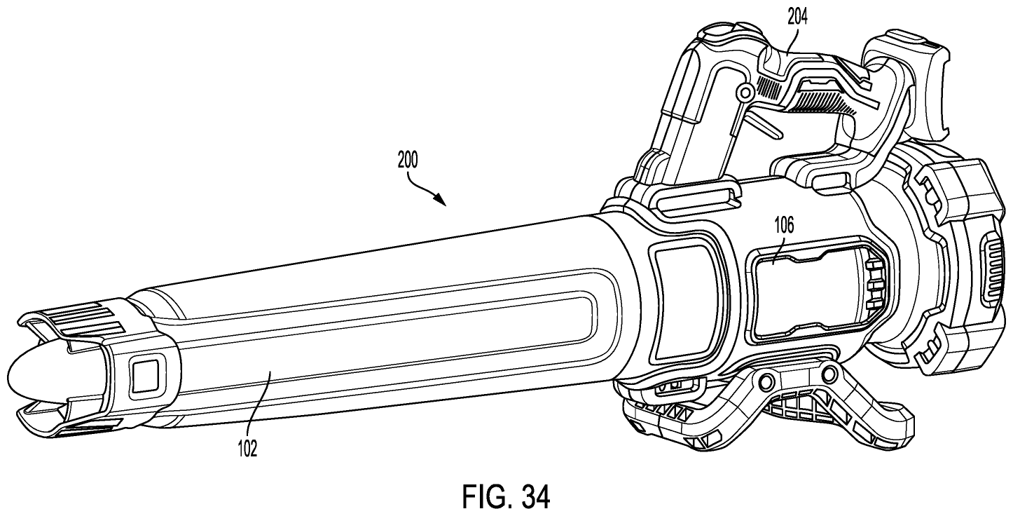

FIGS. 34-36 show a sixteenth embodiment of the invention.

### DETAILED DESCRIPTION OF THE INVENTION

FIGS. 1-10 show a first embodiment of the present invention. The blower 10 is powered by a battery (not shown) that is attached to the blower through a battery housing 100 with a terminal block 24. Air is propelled out of the blower by a fan 104 through an outlet tube 102. The battery used in the present invention is normally a high voltage battery (60V or higher), which tend to generate more electrostatic charge, but the principles presented herein are applicable to a blower with any battery voltage.

Reference will first be made to FIGS. 9 and 10 to describe the general operation of the blower 10. The blower includes a main housing 106 that holds the fan 104 and motor 108. The outlet tube 102 is connected to the housing 106, with a portion of the outlet tube 102 including a short clear duct 110 section. A handle 112 extends from the housing 106 and includes a trigger 114 for actuating the motor 108. The motor is powered by a battery, but the present invention could be used with a corded blower or a gas powered blower as well. The handle 112 is shown as being formed as part of the housing 106, but alternatively it can be formed separately and attached. The main housing 106 includes an air inlet having an intake guard 116. Inside the housing 106 is a baffle 17 that surrounds the motor 108 and fan 104.

The handle 112 includes a handle contact 14 made up of an exposed solid wire that the user contacts when the handle is grabbed (see FIG. 3). The contact 14 is connected to a stranded wire 12, which is connected to a bracket 16 (see FIG. 2) that's secured to a module 20. The bracket 16 can be made of steel or other conductive material. FIG. 4 shows the wire 12 along with other electrical wires used in the blower and FIG. 5 shows only the wire 12 for clarity. The use of a stranded wire 12 (as opposed to a solid wire like in the handle) increase the surface area that's in contact with the baffle 17 and improves the transfer of static electricity to the stranded wire 12. The wires 12 and contact 14 are shown as crimped together at 13, but they can be formed as a single piece and of the same material, or that various parts of the conductive wire path can be made from different materials as needed.

FIGS. 4 and 5 show the stranded wire 12 routed around the baffle 17 and held in contact with its outside surface by a series of ribs 18. The increased contact with the baffle 17 surface improves the collection of any surface charge that collects on the baffle during use.

The wire 12 is also connected to the bracket 16 via a ring terminal by a screw 118. FIG. 7 shows the bracket 16 touching a module 20 (eg. the electronic control unit) and works as a spring so that it is in constant contact with the module 20 at all times. The bracket 16 collects any charge that accumulates on the module 20, and the uninsulated wire 12 collects any charge on the baffle and conveys the charge to the contact 14 to be discharged through the user when the handle is grabbed. The user represents the path of least resistance and acts as a ground. In this way, the bracket 16 and stranded wire 12 prevent any static electricity from building up, and prevent an uncomfortable discharge being passed to the user.

The remaining figures show various alternative embodiments of the invention, where similar parts have been labelled with the reference numbers found in FIGS. 1-10 for convenience. Furthermore, in some figures, the wire 12 and contact 14 have been shown as a single oversized line for easier visibility, but it should be understood that the wire 12 and/or contact 14 can by any thickness or size, and split into multiple parts as needed for the purpose of attracting and transferring electric charge within the blower.

FIG. 11 show a second embodiment of the invention. It's similar to the first embodiment except the stranded wire 12 is taped to the wires of the control module 20 by electrically conductive tape 22, for example aluminium tape. The aluminium tape 22 helps collect and transfer any static electricity by increasing the surface area of the conductive material, which then collects more charge and prevents it from travelling elsewhere. By connecting the wire 12 to the aluminium tape, this gives any accumulated charge a direct path to the user (ground) and prevents arcing.

FIG. 12 show a third embodiment of the invention. It's similar to the earlier embodiments, except the tape 22 overlays all the wires of the control module 20 and motor phase wires 30, against the baffle 17. Again, this increases the surface area of contact against the baffle and increases the likelihood that any accumulated charge will transfer to the wire 12 and contact 14.

FIG. 13 shows a fourth embodiment of the invention. It's similar to the embodiment shown in FIG. 12 except the aluminium tape 22 overlays just the module wires (and not the motor phase wires).

FIGS. 14 and 15 show a fifth embodiment of the invention. Here, the contact 14 in the handle is connected by a stranded wire 12 to a battery terminal 24 for the blower. In an embodiment of the invention, the stranded wire 12 is connected to the negative (B−) battery terminal, which acts as a ground for the circuit.

FIGS. 16 and 17 show a sixth embodiment of the invention. It's similar to the previous embodiments, but here the stranded wire 12 runs from the contact 14 in the handle to a screw 118 on the baffle. It is similar to the embodiment shown in FIG. 6, but without the bracket 16.

FIGS. 18-20 show a seventh embodiment of the invention. It's similar to the previous embodiments, except here the stranded wire 12 runs from the contact 14 to the module 20, and to the stator of the motor 108. The wire 12 is connected to the module 20 through a bracket 16 as in previous embodiments. The motor 108 is located inside the baffle 17, so the wire 12 enters the baffle 17 through an opening 120. It is believed that a majority of the static charge is created by the fan. The stator of the motor 108 is comprised of steel laminations that act as a conductor due to its material and mass, and therefore connecting the wire to the stator would collect the most charge since the motor is closest to the fan.

FIGS. 21 and 22 show an eighth embodiment of the invention. Here, the wire 12 runs from the contact 14 to the module 20 (via bracket 16), which is wrapped with aluminium tape 22. The aluminium tape 22 creates a faraday cage preventing static charge from entering the module 20 and causing damage.

FIGS. 23 and 24 show a ninth embodiment of the invention. Here the wire 12 runs from the contact 14 to a front portion of the handle 112 and held by a screw 26 in an existing screw boss. It is believed that the handle housing collects static charge from the baffle 17 and in this way is able to safely discharge it to the user.

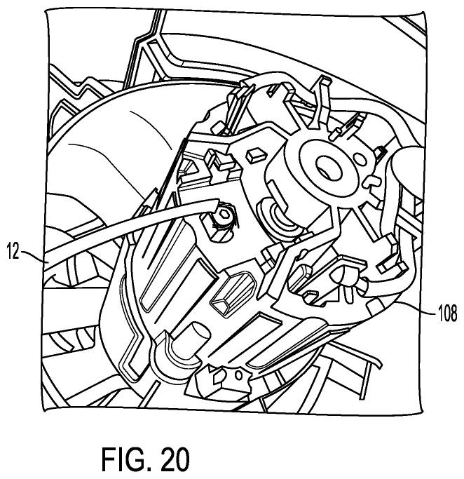

FIG. 25 show a tenth embodiment of the invention. Here the wire 12 is run from the contact 14 directly to the stator of the motor 108, and is connected to the motor as shown in FIG. 20. This is similar to embodiment seven, except here there is no separate wire that is concurrently run to the module 20.

FIG. 26 show an eleventh embodiment of the invention. Here the wire 12 connects the contact 14 to the stator of the motor 108 (similar to FIG. 25) through the baffle opening 120, but additional another wire 12 connects the contact 14 to a terminal 24 for the battery (similar to FIG. 14).

FIGS. 27 and 28 show a twelfth embodiment of the invention. Here the wire 12 connects the stator and rotor of the motor directly to a terminal 24 for the battery (ie. no contact 14 in handle). The wire 12 is connected to the stator as previously discussed, but is also connected to the rotor through a small hole 122 in the motor housing. In an embodiment of the invention, the wire is connected to a negative terminal of the battery as previously discussed with respect to FIG. 15.

FIG. 29 shows a thirteenth embodiment of the invention. Here the wire 12 connects the stator of the motor 108 directly to a terminal 24 for a battery (ie. no contact 14 in handle). The connection to the motor stator is through the opening 120 in the baffle 17 as previously discussed, and in an embodiment, the wire is connected to a negative terminal of the battery.

FIGS. 30 and 31 shows a fourteenth embodiment of the invention. Here the contact 14 in the handle is connected by wire 12 to the module 20 (via bracket 16), and to a terminal 24 for the battery.

FIG. 32 show a fifteenth embodiment of the invention. Here, the metal wire in the handle is connected to the fan/baffle and to a terminal for the battery. In a further embodiment of the invention, the metal wire is connected to a negative terminal for the battery.

FIGS. 34-36 show a sixteenth embodiment of the invention. The blower 200 is similar to the blower shown in FIG. 1, with some minor changes, particularly to the position of its battery 202. Like the earlier blower, the blower 200 has a main housing 106 and an outlet tube 102, and a motor and fan inside the main housing 106.

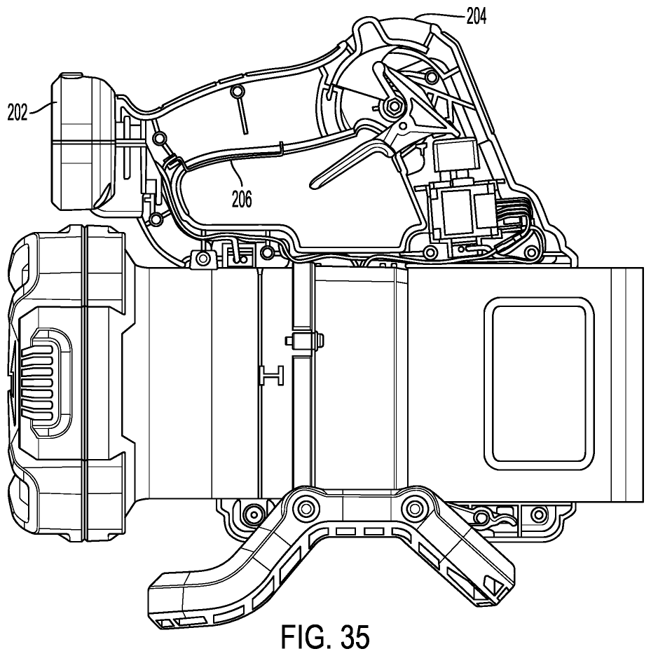

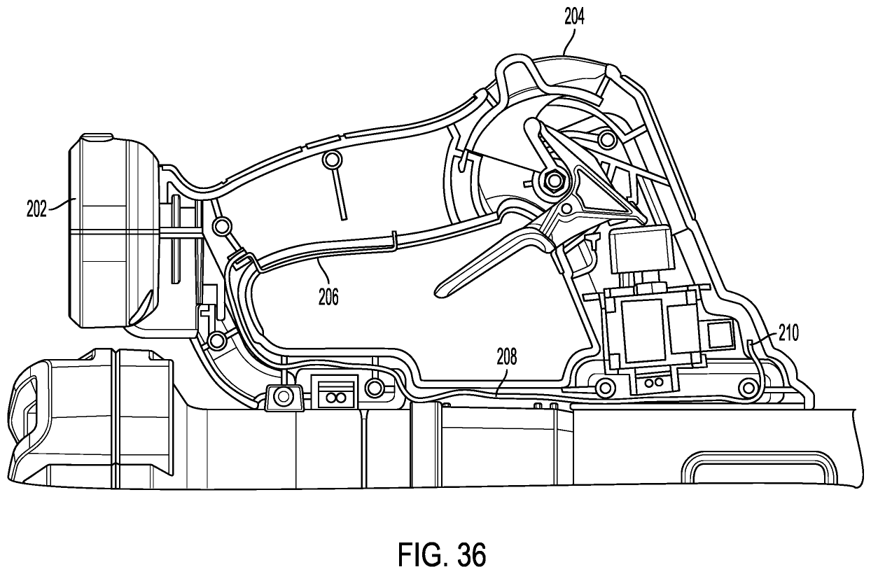

The blower 200 has a handle 204 with an exposed contact wire 206 which the user touches upon grabbing the blower. The contact wire 206 is connected to a stranded wire 208 that runs to the front of the handle 204. FIG. 35 shows the handle 204 with the various wires running through it, while FIG. 36 shows the handle with just the stranded wire 208 for clarity. FIG. 36 shows the end 210 of the stranded wire 208 as loose within the handle and not secured to the housing.

It is envisioned that the blower 200 uses a lower voltage battery, for example a 20V battery, which generates a lower level of electrostatic charge. Therefore any charge that does build up collects within the electrical wires and can be transferred to the stranded wire 208 which is placed in contact or close proximity to these existing wires. And from the stranded wire 208, the charge can be safely passed to the user through the contact wire 206.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A blower comprising:
a housing;
a fan inside the housing for blowing air;
a motor for powering the fan;
a module for controlling the operation of the motor;
a contact wire in the handle, the contact wire being made of an electrically conductive material and being exposed so that a user will touch the contact wire when grasping the handle; and
the contact wire and the module being connected by an electrically conductive wire.

2. The blower of claim 1, further comprising:
a battery for powering the motor, and the contact wire and the battery being connected by an electrically conductive wire.

3. The blower of claim 2, wherein the negative terminal of the battery is connected to the conductive wire.

4. The blower of claim 1, wherein the blower is an axial blower where the fan has a central axis, and the motor has a central axis, and the central axis of the fan and the central axis of the motor are parallel.

5. The blower of claim 1, further comprising a baffle surrounding the fan and the motor, and the wire is secured to the baffle.

6. The blower of claim 1, further comprising a bracket secured to the module, and the wire is connected to the bracket.

7. The blower of claim 6, wherein the bracket is biased against the module.

8. The blower of claim 1, wherein the wire is a stranded wire.
